(19) United States
(12) Patent Application Publication
(10) Pub. No.: US 2019/0253333 A1
(43) Pub. Date: Aug. 15, 2019

(54) METHODS AND DEVICES FOR NETWORK WEB RESOURCE PERFORMANCE

(71) Applicant: CA, Inc., New York, NY (US)

(72) Inventor: Douglas Briere, Cupertino, CA (US)

(21) Appl. No.: 15/894,282

(22) Filed: Feb. 12, 2018

(51) Int. Cl. H04L 12/26; G06F 17/30; G06F 3/0483; H04L 29/08

(52) U.S. Cl. CPC H04L 43/0817; G06F 17/30902; H04L 67/02; G06F 3/0483; G06F 17/3089

(57) ABSTRACT

A method includes performing, by a processor, receiving a user selection of a content item on a web page in a web browser executing on a device, obtaining resource timing information corresponding to network timing information associated with a web resource associated with the content item, determining a callback execution time associated with the web resource, aggregating performance information comprising the resource timing information and the callback execution time associated with the web resource, and communicating, to a network operator, the performance information comprising the resource timing information and the callback execution time associated with the web resource.

### BACKGROUND

Worldwide access to the World Wide Web has led to organizations and businesses using web sites as a way to provide information to customers. With faster network speeds to access web sites and increased content on the Web, the performance and speed of operation and navigation of web sites may be important to web site owners. Network providers wish to quantify the performance of web sites and improve the operation and trouble shooting of web sites. While performance management software may be used to collect diagnostic data on web site performance, an administrator or other engineering staff may lack tools for analyzing the diagnostic information and identifying the source of performance problems or mitigate the effects of performance problems.

### SUMMARY

Various embodiments of the present invention are directed to a method including performing operations as follows on a processor. The operations include receiving a user selection of a content item on a web page in a web browser executing on a device, obtaining resource timing information corresponding to network timing information associated with a web resource associated with the content item, determining a callback execution time associated with the web resource, aggregating performance information including the resource timing information and the callback execution time associated with the web resource, and communicating, to a device associated with the network operator, the performance information including the resource timing information and the callback execution time associated with the web resource.

In some embodiments, operations performed on the processor may include sending a request to obtain the web resource associated with the content item, responsive to the receiving the user selection, and performing a callback operation, responsive to completion of the sending the request. A resource table may be processed by performing operations including the resource timing information, responsive to a completion of the performing the callback operation. Sending the request to obtain the web resource may include determining a system request send operation associated with the web resource, responsive to the receiving the user selection, and executing a send wrapper operation that redefines the system request send operation, responsive to the determining the system request operation. Operations may include determining a request start time associated with the web resource, responsive to the executing the send wrapper operation, and setting a harvest ready flag to an indication of not being ready to harvest a resource table including the resource timing information.

In some embodiments, performing the callback operation may include executing a callback wrapper operation that redefines the callback operation, and determining a callback execution time associated with the web resource. Determining the callback execution time associated with the web resource may include determining a callback execution start time, executing the callback operation, and determining a callback execution end time. The callback execution time may include the callback execution start time and the callback execution end time.

In some embodiments, operations may include setting a harvest ready flag to an indication of being ready to harvest the resource table including the resource timing information, responsive to the performing the callback operation. A resource table including the resource timing information may be processed, responsive to the harvest ready flag indicating being ready to harvest the resource table. Processing the resource table including the resource timing information may include generating a binary sorted proprietary resource list based on a plurality of web resources in the resource table, and determining the resource timing information associated with the web resource, wherein determining the resource timing information associated with the web resource including processing elements of the binary sorted proprietary resource list.

In some embodiments, determining the callback execution time associated with the web resource may include correlating the callback execution time associated with the web resource with an element of the binary sorted proprietary resource list, and associating the callback execution time with the resource timing information of the web resource based on the correlating the callback execution time. Correlating the callback execution time associated with the web resource with the element of the binary sorted proprietary resource list may include identifying an element of the binary sorted proprietary resource list. Identifying the element of the binary sorted proprietary resource list may include performing a binary search of the binary sorted proprietary resource list.

In some embodiments, correlating the callback execution time associated with the web resource with the element of the binary sorted proprietary resource list may further include determining an index of the element of the binary sorted proprietary resource list that was identified, and identifying the callback execution time associated with the web resource, based on the index of the element of the binary sorted proprietary resource list.

Various embodiments of the present inventive concept include an electronic device, including a processor, and a memory coupled to the processor and including computer readable program code embodied in the memory that when executed by the processor causes the processor to perform operations as follows on a processor. The operations include receiving a user selection of a content item on a web page in a web browser executing on a device, obtaining resource timing information corresponding to network timing information associated with a web resource associated with the content item, determining a callback execution time associated with the web resource, aggregating performance information including the resource timing information and the callback execution time associated with the web resource, and communicating, to a network operator, the performance information including the resource timing information and the callback execution time associated with the web resource.

In some embodiments, the processor of the electronic device may be further configured to perform operations including sending a request to obtain the web resource associated with the content item, responsive to the receiving the user selection, performing a callback operation, responsive to completion of the sending the request, and processing a resource table including the resource timing information, responsive to a completion of the performing the callback operation. The processor may be further configured to perform operations including determining a system request send operation associated with the web resource, responsive to the receiving the user selection, executing a send wrapper operation that redefines the system request send operation, responsive to the determining the system request operation, setting a harvest ready flag to an indication of not being ready to harvest a resource table including the resource timing information, executing a callback wrapper operation that redefines the callback operation, and determining a callback execution time associated with the web resource. The callback execution time may include the callback execution start time and the callback execution end time.

In some embodiments, the processor of the electronic device may be further configured to perform operations including setting a harvest ready flag to an indication of being ready to harvest the resource table including the resource timing information, responsive to the performing the callback operation, generating a binary sorted proprietary resource list based on a plurality of web resources in a resource table, responsive to the harvest ready flag indicating being ready to harvest the resource table, and determining the resource timing information associated with the web resource, wherein determining the resource timing information associated with the web resource includes processing elements of the binary sorted proprietary resource list.

In some embodiments, the processor of the electronic device may be further configured to perform operations including correlating the callback execution time associated with the web resource with an element of the binary sorted proprietary resource list, identifying an element of the binary sorted proprietary resource list, wherein the identifying the element of the binary sorted proprietary resource list includes performing a binary search of the binary sorted proprietary resource list, associating the callback execution time with the resource timing information of the web resource based on the correlating the callback execution time, determining an index of the element of the binary sorted proprietary resource list that was identified, and identifying the callback execution time associated with the web resource, based on the index of the element of the binary sorted proprietary resource list.

Various embodiments of the present inventive concept include a computer program product, that includes a non-transitory computer readable storage medium storing computer readable program code which when executed by a processor of an electronic device causes the processor to perform operations as follows on a processor. The operations include receiving a user selection of a content item on a web page in a web browser executing on a device, obtaining resource timing information corresponding to network timing information associated with a web resource associated with the content item, determining a callback execution time associated with the web resource, aggregating performance information including the resource timing information and the callback execution time associated with the web resource, and communicating, to a network operator, the performance information including the resource timing information and the callback execution time associated with the web resource.

It is noted that aspects described with respect to one embodiment may be incorporated in different embodiments although not specifically described relative thereto. That is, all embodiments and/or features of any embodiments can be combined in any way and/or combination. Moreover, other methods, systems, articles of manufacture, and/or computer program products according to embodiments of the inventive subject matter will be or become apparent to one with skill in the art upon review of the following drawings and detailed description. It is intended that all such additional systems, methods, articles of manufacture, and/or computer program products be included within this description, be within the scope of the present inventive subject matter, and be protected by the accompanying claims. It is further intended that all embodiments disclosed herein can be implemented separately or combined in any way and/or combination.

### BRIEF DESCRIPTION OF THE DRAWINGS

Features of embodiments will be more readily understood from the following detailed description of specific embodiments thereof when read in conjunction with the accompanying drawings, in which:

FIG. 1 is a block diagram that illustrates a communication network including a user device for which performance information may be provided to a network operator, according to some embodiments of the present inventive concept.

FIGS. 2, 3, 4, and 5A/5B are flowcharts of operations for determining web resource performance, according to some embodiments of the present inventive concept.

FIGS. 6A and 6B are examples of performance information related to web resources, according to some embodiments of the present inventive concept.

FIGS. 7 to 19 are flowcharts that illustrate operations for aggregating performance information, according to some embodiments of the present inventive concept.

FIG. 20 is a block diagram that illustrates a software/hardware architecture for use in the electronic device of FIG. 1, according to some embodiments of the present inventive concept.

### DETAILED DESCRIPTION

In the following detailed description, numerous specific details are set forth to provide a thorough understanding of embodiments of the present disclosure. However, it will be understood by those skilled in the art that the present invention may be practiced without these specific details. In some instances, well-known methods, procedures, components and circuits have not been described in detail so as not to obscure the present disclosure. It is intended that all embodiments disclosed herein can be implemented separately or combined in any way and/or combination. Aspects described with respect to one embodiment may be incorporated in different embodiments although not specifically described relative thereto. That is, all embodiments and/or features of any embodiments can be combined in any way and/or combination.

Businesses, applications, organizations, and/or groups use web pages as an interface to users. Ubiquitous availability of computers and/or mobile devices provide access to most persons worldwide to a web browser capable of connecting to the internet and accessing websites associated with businesses, applications, organizations, and/or groups. Websites may include numerous web pages that each provide different information to users. Some websites may have a separate web page for each use case, such as a home page (home.html), products page (products.html), about page (about.html), etc. As a user navigates a web page, user selections may trigger one or more resources to be transferred to the browser. However, if a significant amount of time is needed to obtain or download these resources, the user may see a busy signal, such as an hour glass on the user interface or display. Long wait times are generally unacceptable to users and diminish the user experience on a web page. Therefore, network operators may desire to have information regarding performance of webpages and specific information about individual resources.

Resources within a web page can be classified as two major types: static or dynamic. Static resources may include items that are downloaded automatically through HTML tags such as <script>, <img>, <css> etc. Dynamic resources may be variable content, which is either uploaded or downloaded in a web request, such as an Asynchronous JavaScript And XML (AJAX) request. For example, AJAX in JavaScript may use an XMLHttpRequest (or helper frameworks such as j Query) to enable the browser/client to send/receive content from a remote web server. However, many types of content may be obtained through this framework, and thus XML is discussed herein as a non-limiting example. Additionally, in some embodiments, web requests, such as AJAX requests, may support a synchronous calling mode, although it may not be preferred in some applications since the synchronous call mode may block the user experience. Thus, the non-limiting examples described herein will be in the context of asynchronous web/AJAX requests. In either the synchronous or asynchronous cases, the framework response, which may take notable time to process on the client/browser, may be processed in a variety of user implemented function callbacks such as onload, onloadend and readystatechange. Some embodiments described herein are described with reference to a function. A function may be software that runs on a processor. A function may be used to refer to methods in a web environment or an object-oriented environment, in some embodiments. Providing the timing measurements on these functions is something a tool such as the CA Technologies Browser Agent may do to provide metrics such as the Callback Execution Time (CBET). However, the CBET may not be as useful by itself but may be more valuable when used in conjunction with other performance information for the resources.

Timing metrics may be obtained for many resources through the Performance Resource Timing (PRT) API provided by JavaScript/Browser. Specifically, these timing metrics may provide timing visibility into aspects of the network call for a given resource, such as domain lookup start/end, connection start/end, etc. CBET for a resource may not be provided by the performance resource timing API, but may be obtained via proprietary instrumentation, as described herein. Being able to correlate CBET with other timing metrics from PRT may provide a superior and more complete start-to-end call life-cycle on the true timing cost of a web resource. From request to response to client side processing, the CBET may provide an end-to-end view that may be important to understand the performance of a web page.

When a web page is performing AJAX related functionality, often times a busy spinner may appear, indicating that a portion of the page is undergoing an asynchronous update. Web page users are often free to click elsewhere on the page during this asynchronous update. However, if a user is waiting for a significant amount of time on the portion of the page, then the user experience may be suboptimal. For example, if a user is on a news website, the user may click a “more” content item on the web page to obtain more news stories. However, this updating of more news stories may take a long time, from the user's point of view. It may be desired by a network operator and/or a network provider to understand the source of the problem such a problem in the network, or a problem in the client side processing. Many different metrics considered together may provide a higher level of resource visibility. It may be desired to provide CBET metrics for AJAX resources. In other words, the CBET cost may be desired along with the PRT metrics for individual web resources to identify bottleneck related to the webpage.

Determining correlation between the CBET and the PRT metrics for individual web resources may not easy in many cases. A first challenge may be that the web browser/PRT API may not notify when a new resource has completed. For example, completed AJAX resources may be added to the web browser's PRT table (i.e. resource table), but there may not be a way in a web script such as JavaScript to register a callback on the resource table. Thus the resource table may need to be checked periodically to look for new updates. Since an instrumentation tool may not know when a web resource will complete, proprietary resource instrumentation for CBET may be needed to reconcile the CBET time against resource table entries. The ordering of reconciliation may be important.

Once a CBET has been determined, the resource table may be searched. However, the resource table may not yet contain an entry during CBET determination. Another challenge is that a resource could have the same name, which would look identical in the table. This may be solved by using the name and resource start time compared with the name and start time obtained from tool's proprietary instrumentation. However, this solution could pose an issue since JavaScript's Date function could be offset by several milliseconds compared to the entry in resource table. Therefore, the start time of the resource must be within an acceptable threshold. Another challenge may be that the duration value on the PRT object may be computed by the web browser tool by using a difference responseEnd—startTime. However, if the browser tool adds the CBET, which essentially occurs in a final phase, then the total duration may need to be updated again. Duration may be a difference between the callback execution end time and the callback execution start time, (e.g. callbackExecutionTime End—callbackExecutionTime startTime). Thus total duration for the resource will then be callbackExecutionTime End—startTime. Details of obtaining the CBET will now be described with respect to the accompanying figures.

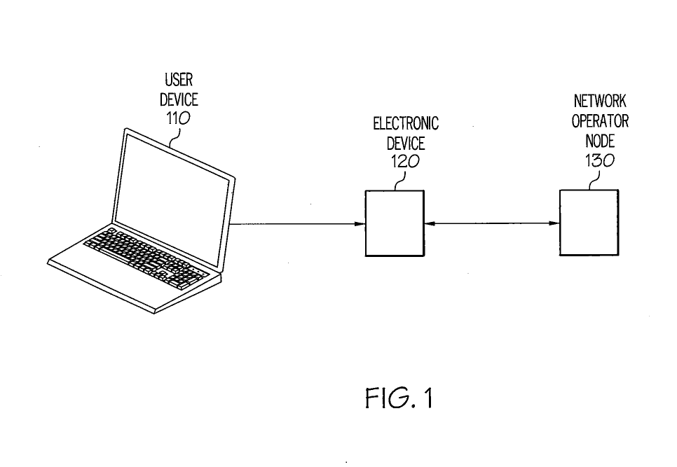

FIG. 1 is a block diagram that illustrates a communication network including a user device for which performance information may be provided to a device associated with the network operator. As used herein, the term “user device” may include a personal computer, a satellite or cellular radiotelephone with or without a multi-line display, a Personal Communications System (PCS) terminal that may combine a cellular radiotelephone with data processing, facsimile and data communications capabilities, a Personal Digital Assistant(PDA) or smart phone that can include a radiotelephone, pager, Internet/intranet access, Web browser, organizer, calendar and/or a Global Positioning System (GPS) receiver, a conventional laptop and/or palmtop receiver, and/or other appliance that includes a communication transceiver. As used herein, an “electronic device” may include any of the types of devices that perform as a user device. An “electronic device” may include servers, data center equipment, or other devices that include a communication transceiver and/or a processor. As used herein, a “network operator” may include a service provider, web hosting service, Internet/Intranet administrator nodes, and/or other nodes in a communications network. As used herein, a “selection” may be user selection in a web browser by specifying a URL, a mouse click, touch screen selection and/or other indication from a user to navigate within a web browser.

Referring now to FIG. 1, a user device 110 may be used to execute a web browser. A user may use an interface, such as a mouse and/or keyboard, to provide a user selection to navigate to a web page in the web browser. An electronic device 120 may perform operations to identify one or more web resources and/or related timing information associated with the web resources. In some embodiments, the user device 110 and the electronic device 120 may be co-located and/or integrated into a single housing. The electronic device 120 may communicate performance information related to the web page accessed by the user to a network operator node 130. In some embodiments, the electronic device 120 and/or a network operator node 130 may be co-located and/or integrated into a single housing. In some embodiments, the user device 110, the electronic device 120, and/or the network operator node 130 may be physically separated from one another and communicate with one another using transceivers in the various devices across one or more networks.

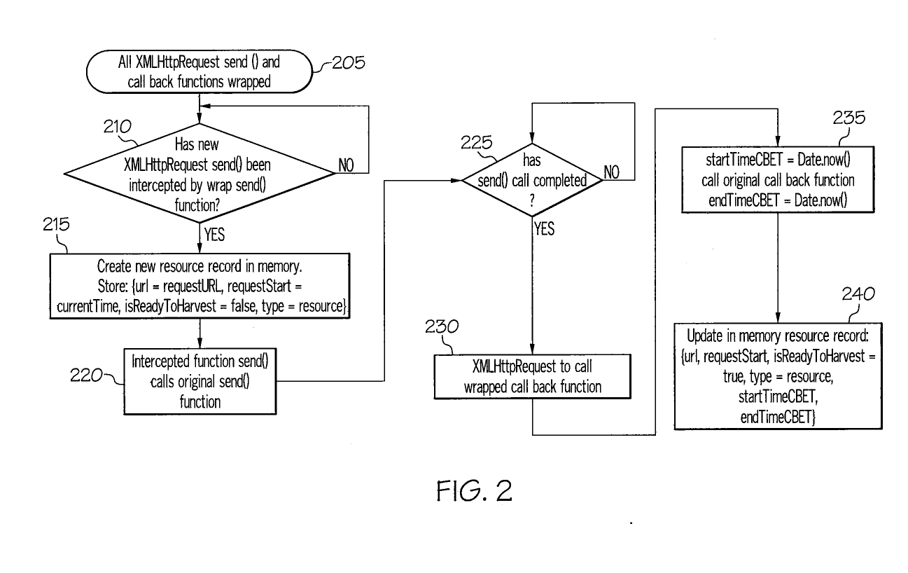

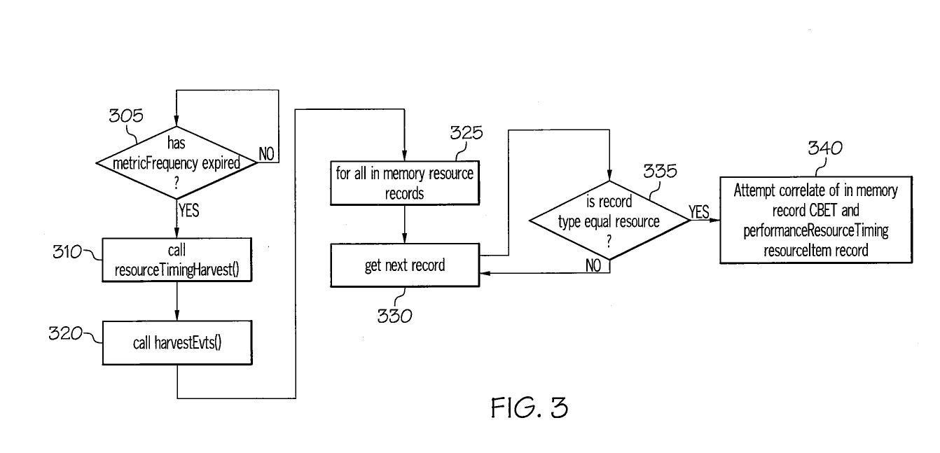

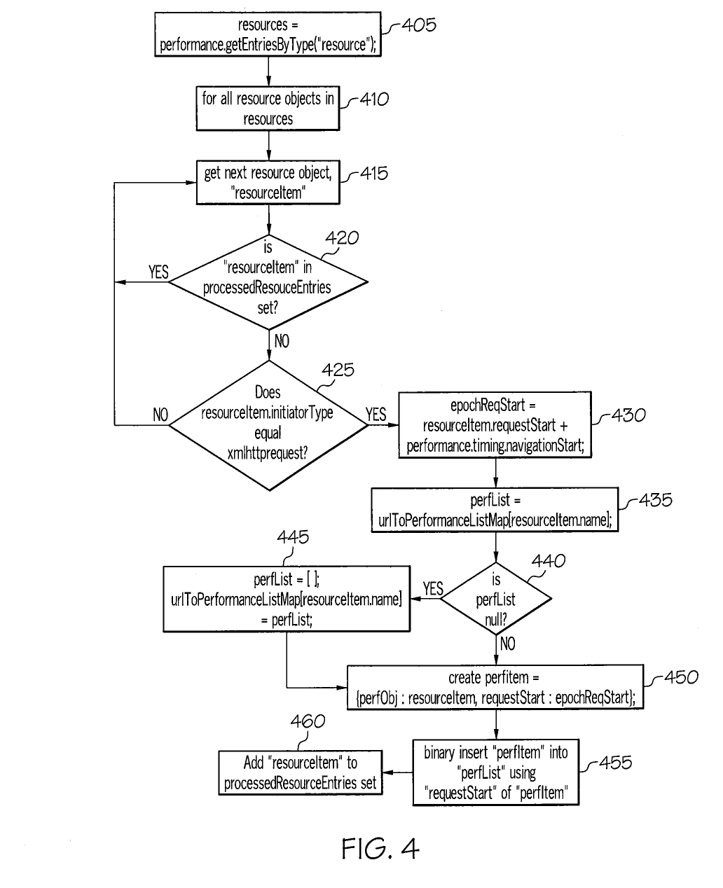

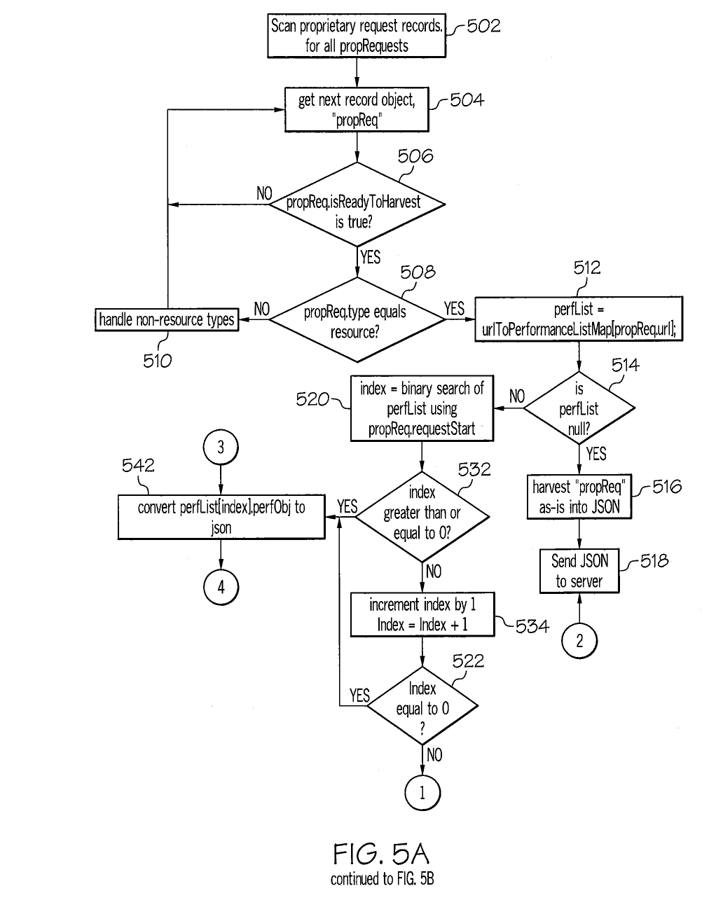

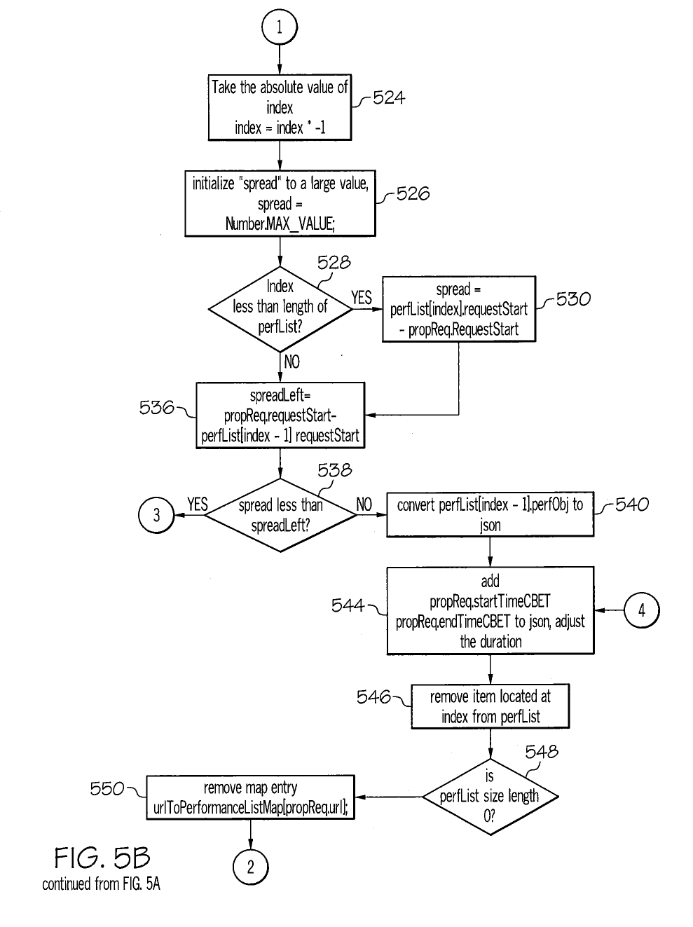

FIGS. 2, 3, 4, and 5 are flowcharts of operations for determining web resource performance. FIG. 2 illustrates operations related to wrapping of a web request and determining timing related to the callback execution. FIG. 3 illustrates high level operations related to harvesting the resource table and correlating callback execution times with elements of the resource table. FIG. 4 provides details related to harvesting the resource table. FIG. 5A/5B provides details regarding the correlation of the callback execution times with elements of the resource table.

Referring now to FIG. 2, operations to wrap the sending of a request to obtain web resources, such as sending an XMLHttpRequest.send( ), and wrapping of the callback function begin, at block 205. A wrapping send function intercepts the original XMLHttpRequest.send( ) function by checking to see if a new XMLHttpRequest.send( ) has been intercepted by the wrapped send function, at block 210. This check may be performed repeatedly until a XMLHttpRequest.send( ) is received. When the XMLHttpRequest.send( ) is received, a time for starting the XMLHttpRequest may be saved. A new resource record may be then created in memory, at block 215. The new resource record may be a proprietary record. As multiple web resources may be requested by a given web page, multiple resource records may be created. These multiple resource records may not be in any particular order since processing of the requests may vary in time. The resource record may be stored in a record, for example, {url=requestURL, requestStart=currentTime, isReadyToHarvest=false, type=resource}. The intercepted function send( ) may call the original send function, such as XMLHttpRequest.send( ), at block 220.

Still referring to FIG. 2, a check may be performed to determine if the send( ) call has completed, at block 225. Operations may be waiting at block 225 until completion of the send( )call. An indication that the record is ready to be harvested may be set to false. Once the send( )call has completed, an XMLHttpRequest to call a wrapped callback function may be executed, at block 230. Calling of the wrapped callback function may include capturing the callback execution start an end times, prior to and after the calling of the original callback function, respectively, at block 235. Based on the callback execution start time and the callback execution end time, the CBET may be determined, according to some embodiments. The resource record may be updated by correlating the CBET to the resource records, at block 240. For example, fields that may be updated in the resource record may include {url, requestStart, isReadyToHarvest=true, type=resource, startTimeCBET, endTimeCBET}. The resource record may be updated using, for example, an AJAX call.

Referring now to FIG. 3, which illustrates harvesting the resource table and correlating callback execution times with elements of the resource table, a timer for periodic resource harvesting is checked to determine if a metric frequency has expired, at block 305. If the timer has expired, a call may be made to resourceTimingHarvest( ) to trigger harvesting of the resource table, at block 310. A resource table may be harvested based on a call to harvestEvts( ), at block 320. Harvesting the resource table may include processing the resource table, and scanning the proprietary request records stored in memory of block 240 of FIG. 2. For all resource records in memory, at block 325, individual records may be obtained, at block 330. The resource records in memory accessed at block 325 may be proprietary resource records that include the resource time information and/or the callback execution time (CBET). A determination is made if the record from the resource records in memory has a type equal to the resource that is being processed, at block 335. If the type of the resource record is equal to record being searched, at attempt is made to correlate the memory record's CBET and the performance resource timing of the resource item record, at block 340.

FIG. 4 provides further details regarding the operations described with respect to FIG. 3. Referring to FIG. 4, web browser performance timing records of resources on a web page may be in a list that can be access by type using, for example, resources =performance.getEntriesByType(“resource”), at block 405. The performance timing information in the performance timing records of resources may correspond to the performance timing information of FIG. 6A. For all resource objects in the records of resources, at block 410, the next resource item or resource object may be obtained, at block 415. A check may be performed to determine if the resource item is in a processed resource entries set, at block 420. If the resource item is in the processed resource entries set, then another resource item is checked at block 415. Otherwise, a check may be performed to determine if the resource item initiator type is equal to the request, such as equal to xmlhttprequest, at block 425. If the resource item initiator type is not equal to the request, then another resource item is checked at block 415. If the resource item initiator type is equal to the request at block 425, then the epoch request start time is set to the resource item request start time plus the performance timing navigation start time, at block 430.

Still referring to FIG. 4, the performance list may be consolidated to track the url to performance list map by setting perfList=urlToPerformanceToListMap [resourceItem.name], at block 435. A check if performed to determine if the resource item is in the perf list by checking if the perfList is null, at block 440. If the perfList is null, then a list is created, at block 445. For example, creating the list may include perfList=[ ] and urlToPerformanceListMap [resourceItem.name]=perfList. If the perfList already exists at block 440, a new item is added to the list, at block 450. Adding the new item may include, for example, create perfitem={perfObj: resourceItem, requestStart: epochReqStart}. Once the new item is created, a binary insert may be used to place the new resource item into the performance list using the request start value of the performance item, at block 455. The new resource item may be added to the processed resource entries set, at block 460, to make sure that the same resources that have already been processed are not obtained again during operations at block 420.

FIGS. 5A and/or 5B correspond to detailed operations of block 340 of FIG. 3. Proprietary request records may be scanned for all proprietary request records, at block 502. The next record object, such as “propReq” may be obtained at block 504. A check may be performed to determine if the proprietary request is ready to be harvested by checking a flag, at block 506. If the proprietary request is not ready to be harvested, the next record object is obtained, at block 504. If the proprietary request is ready to be harvested at block 506, a check is performed if the proprietary request type equals resource, at block 508. If the proprietary request type does not equal resource, then non-resource type operations are handled, at block 510. If the proprietary request type equals resource, then an attempt is made to obtain the performance from the url map, at block 512 by performing an operation such as perfList=urlToPerformanceListMap[propReq.url].

Still referring to FIG. 5A, if the performance list is null, at block 514, then the proprietary request performance information may be harvested, by placing the information directly into JavaScript Object Notation (JSON) format, at block 516. JSON is an open-standard file format that uses human-readable text to transmit information. This JSON information may be sent to a server, at block 518. If the performance list is not null at block 514, then a binary search may be performed on the performance list using propReq.requestStart as a starting time to search the list, at block 520. Since items were inserted in the performance list using a binary insert procedure, the list is binary sort, making it available to perform a binary search. This binary insertion thus provides the advantage of not having to traverse the entire list, saving considerable search time for web pages that may use many resources. A check may be performed to determine if the index is greater than or equal to 0, at block 532. If the check at block 532 is false, then the index may be incremented by 1, i.e. index=index+1, at block 534. If the check at block 532 is true, then conversion to text may occur in order to transfer to the network operator, at block 542. A check may be performed to determine if the index is equal to 0, at block 522. If the index is equal to 0 at block 522, the conversion to text at block 542 may be performed.

Referring now to FIG. 513, which is continuation of the flowchart of FIG. 5A, If the index is not equal to 0 at block 522 of FIG. 5A, the absolute value of the index may be determined, at block 524 (i.e. index=index*−1). The spread may be initialized to a large value, at block 526, such as a MAX_VALUE. A check may be performed to determine if the index is less than the length of the perfList, at block 528. If the index is less than the length of the perfList, then the spread may be set to perfList[index].requestStart—propReq.RequestStart, at block 530. If the index is not less than the length of the perfList, then the spreadLeft may be set to propReq.RequestStart—perfList[index−1].requestStart, at block 536. A check may be performed to determine if the spread is less than the spreadLeft, at block 538. If the spread is not less than the spreadLeft, resource performance information (i.e. perfList[index−1].perfObj) may be convert to JSON, at block 540. The CBET may be aggregated with the resource performance information (i.e. resource timing information) by, for example, adding propReq.startTimeCBET to propReq.endTimeCBET to JSON, to adjust the duration, at block 544. The item located at the index may be removed from the perfList, at block 546. A check may be performed if the perfList size is length of 0, at block 548. If the perfList size has a length of 0, the map entry is removed since processing and correlation is complete for this proprietary request, at block 55Q, by, for example, remove map entry urlToPerformanceListMap[propReq.url]. Revisiting block 538, if the spread is less than the spreadLeft, then the conversion to text at block 542 of FIG. 5A may be performed.

FIG. 6A includes resource timing information 610 corresponding to network timing information associated with a web resource of a web page. In some embodiments, a function to obtain the resource table (e.g. PRT API) may return a resource object where the timings are offsets from the parent page's navigation start time. FIG. 6B includes aggregated performance information associated with a web resource. The aggregated performance information may include resource timing information 610 and the callback execution time 620.

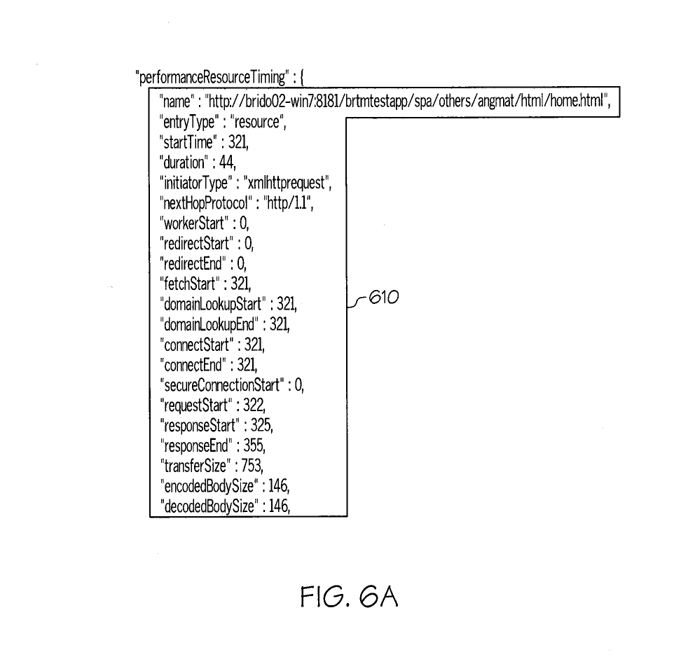

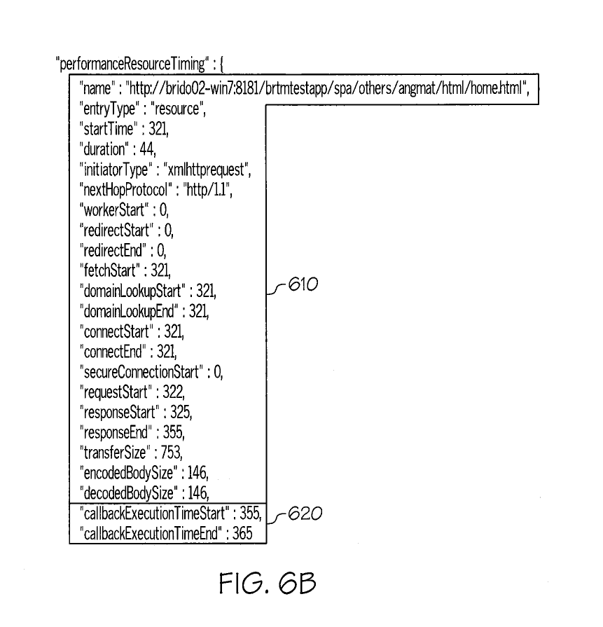

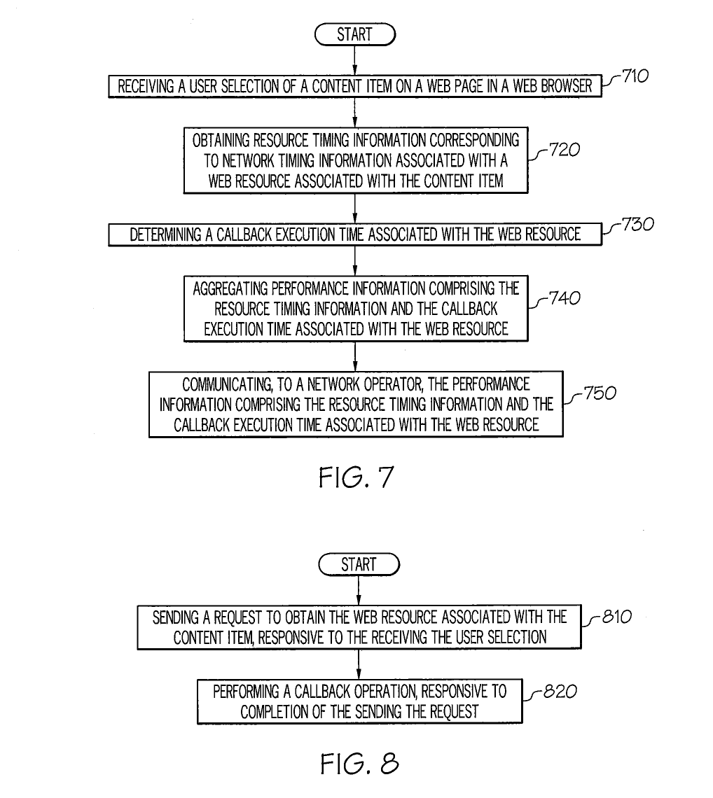

FIGS. 7 to 19 are flowcharts that illustrate operations for aggregating performance information. Referring now to FIG. 7, a user selection of a content item on a web page in a web browser executing on a device may be received, at block 710. Resource timing information corresponding to network timing information associated with a web resource associated with the content item may be obtained, at block 720. A callback execution time associated with the web resource may be determined, at block 730. Performance information including the resource timing information and the callback execution time associated with the web resource may be aggregated, at block 740. The performance information including the resource timing information and the callback execution time associated with the web resource may be communicated to a network operator, at block 750.

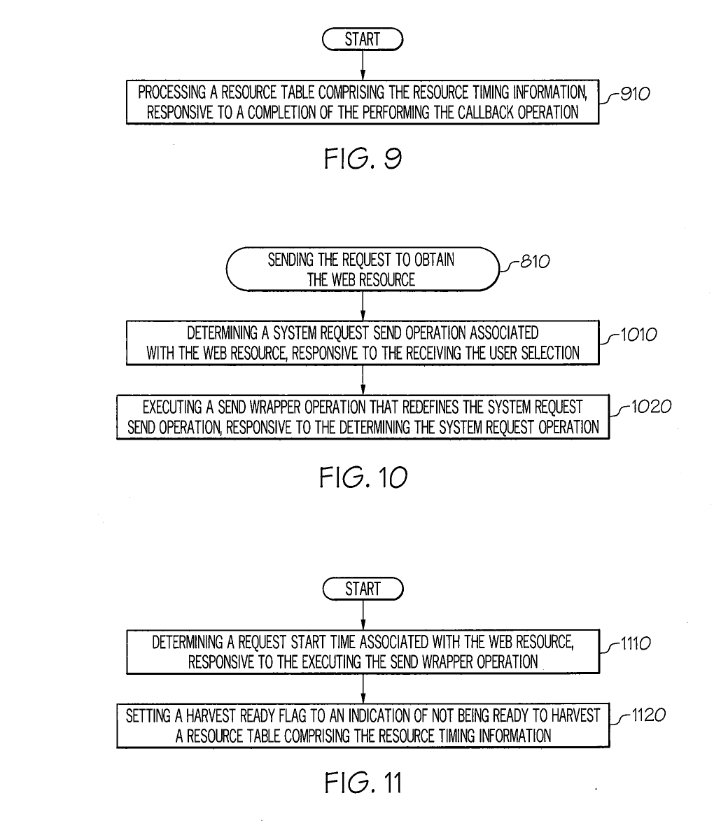

Referring now to FIG. 8, a request may be sent to obtain the web resource associated with the content item, responsive to the receiving the user selection, at block 810. A callback operation may be performed, responsive to completion of the sending the request, at block 820. The callback operation may be an asynchronous call to a callback function. Referring now to FIG. 9, the operations may include processing a resource table including the resource timing information, responsive to a completion of the performing the callback operation, at block 910.

Referring to FIG. 10, in some embodiments, sending the request to obtain the web resource, at block 810 may include determining a system request send operation associated with the web resource, responsive to the receiving the user selection, at block 1010. A send wrapper operation that redefines the system request send operation may be executed, responsive to the determining the system request operation, at block 1020. In some embodiments, a wrapper operation may overload a function, and/or may provide additional functionality in addition to a previous definition of the function.

Referring to FIG. 11, in some embodiments, operations may further include determining a request start time associated with the web resource, responsive to the executing the send wrapper operation, at block 1110. A harvest ready flag may be set to an indication of not being ready to harvest a resource table including the resource timing information, at block 1120.

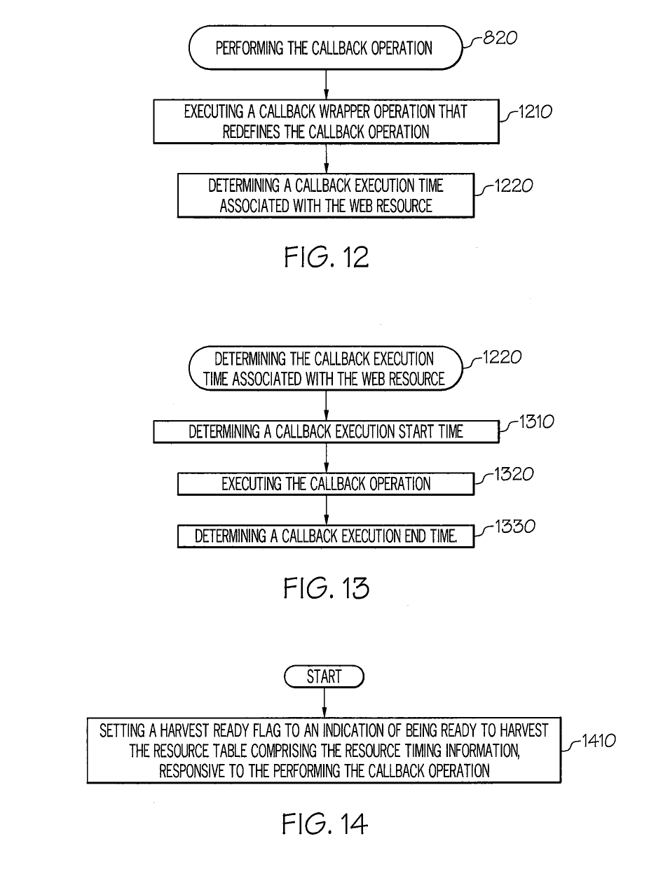

Referring to FIG. 12, in some embodiments, performing the callback operation, at block 820 may include executing a callback wrapper operation that redefines the callback operation, at block 1210. A callback execution time associated with the web resource may be determined, at block 1220.

Referring to FIG. 13, in some embodiments, determining the callback execution time associated with the web resource, at block 1220 may include determining a callback execution start time, at block 1310, executing the callback operation, at block 1320, and/or determining a callback execution end time, at block 1330. In some embodiments, the callback execution time may include the callback execution start time and the callback execution end time.

Referring to FIG. 14, in some embodiments, a harvest ready flag may be set to an indication of being ready to harvest the resource table including the resource timing information, responsive to the performing the callback operation, at block 1410.

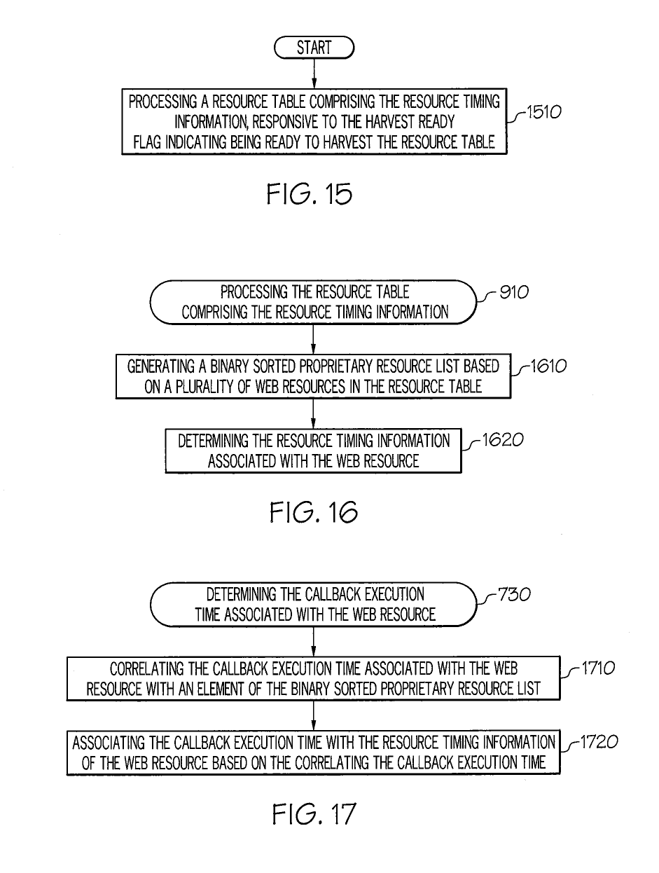

Referring to FIG. 15, in some embodiments, a resource table including the resource timing information may be processed, responsive to the harvest ready flag indicating being ready to harvest the resource table, at block 1510.

Referring to FIG. 16, in some embodiments, processing the resource table including the resource timing information, at block 910 may include generating a binary sorted proprietary resource list based on a plurality of web resources in the resource table, at block 1610. The resource timing information associated with the web resource may be determined, at block 1620. Determining the resource timing information associated with the web resource may include processing elements of the binary sorted proprietary resource list.

Referring to FIG. 17, in some embodiments, determining the callback execution time associated with the web resource, at block 730 may include correlating the callback execution time associated with the web resource with an element of the binary sorted proprietary resource list, at block 1710. The callback execution time may be associated with the resource timing information of the web resource based on the correlating the callback execution time, at block 1720.

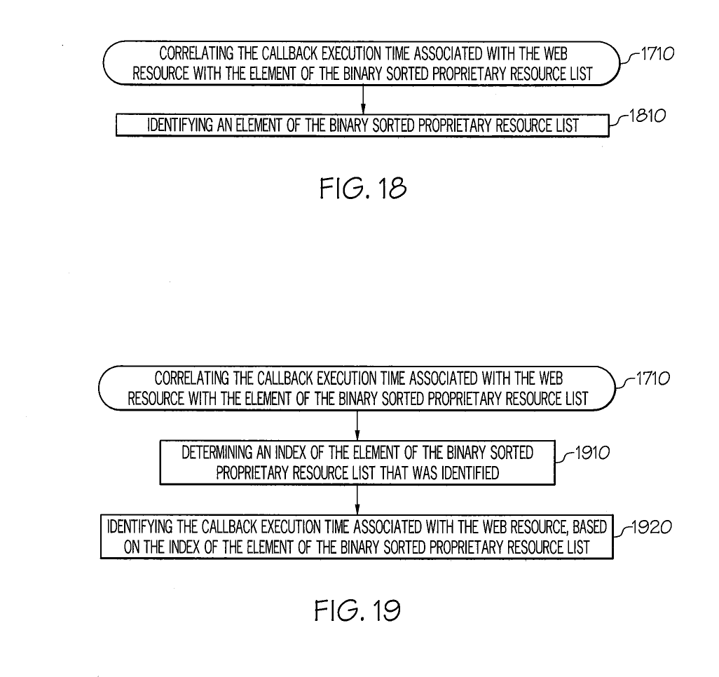

Referring to FIG. 18, in some embodiments, correlating the callback execution time associated with the web resource with the element of the binary sorted proprietary resource list, at block 1710 may include identifying an element of the binary sorted proprietary resource list, at block 1810. Identifying the element of the binary sorted proprietary resource list may include performing a binary search of the binary sorted proprietary resource list.

Referring to FIG. 19, in some embodiments, correlating the callback execution time associated with the web resource with the element of the binary sorted proprietary resource list, at block 1710 may include determining an index of the element of the binary sorted proprietary resource list that was identified, at block 1910. The callback execution time associated with the web resource may be identified, based on the index of the element of the binary sorted proprietary resource list, at block 1920.

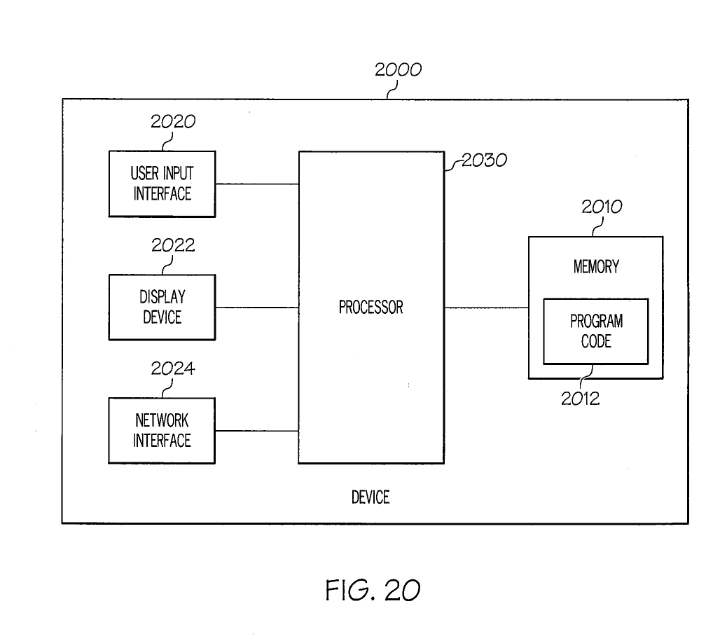

FIG. 20 is a block diagram of an electronic device 2000 configured according to some embodiments. The electronic device 2000 may include the electronic device 120 of FIG. 1. In some embodiments, the electronic device 2000 may be integrated with the user device 110 or with the network operator device 130. Referring to FIG. 20, the electronic device 2000 includes a processor 203Q, a memory 2010, and a network interface 2024 which may include a radio access network transceiver and/or a wired network interface (e.g., Ethernet interface). The radio access network transceiver can include, but is not limited to, a LTE or other cellular transceiver, WLAN transceiver (IEEE 802.11), WiMax transceiver, or other radio communication transceiver configured to communicate with a service provider network or data center operator, such as network operator device 130 of FIG. 1.

The processor 2030 may include one or more data processing circuits, such as a general purpose and/or special purpose processor (e.g., microprocessor and/or digital signal processor) that may be collocated or distributed across one or more networks. The processor 2030 is configured to execute computer program code 2012 in the memory 2010, described as a non-transitory computer readable medium, to perform at least some of the operations described herein as being performed by an electronic device. The computer program code 2012 when executed by the processor 2030 causes the processor 2030 to perform operations in accordance with one or more embodiments disclosed herein for the electronic device 2000. The electronic device 2000 may further include a user input interface 2020 (e.g., touch screen, keyboard, keypad, mouse, etc.) and/or a display device 2022.

### Further Definitions and Embodiments

In the above-description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, JavaScript, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, LabVIEW, dynamic programming languages, such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions, when stored in the computer readable medium, produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

It will be understood that, although the terms “first,” “second,” etc. may be used herein to describe various elements, these elements should not be limited by these terms. These terms are only used to distinguish one element from another. Thus, a first element could be termed a second element without departing from the teachings of the inventive subject matter.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described to best explain the principles of the disclosure and the practical application, and to enable others of ordinary skill in the art to understand the disclosure with various modifications as are suited to the particular use contemplated.

What is claimed is:

1. A method comprising:
performing operations as follows on a processor:
receiving a user selection of a content item on a web page in a web browser executing on a device;
obtaining resource timing information corresponding to network timing information associated with a web resource associated with the content item;
determining a callback execution time associated with the web resource;
aggregating performance information comprising the resource timing information and the callback execution time associated with the web resource; and
communicating, to a device associated with the network operator, the performance information comprising the resource timing information and the callback execution time associated with the web resource.

2. The method of claim 1, further comprising:
sending a request to obtain the web resource associated with the content item, responsive to the receiving the user selection; and
performing a callback operation, responsive to completion of the sending the request.

3. The method of claim 2, further comprising:
processing a resource table comprising the resource timing information, responsive to a completion of the performing the callback operation.

4. The method of claim 3, wherein the sending the request to obtain the web resource comprises:
determining a system request send operation associated with the web resource, responsive to the receiving the user selection; and
executing a send wrapper operation that redefines the system request send operation, responsive to the determining the system request operation.

5. The method of claim 4, further comprising:
determining a request start time associated with the web resource, responsive to the executing the send wrapper operation; and
setting a harvest ready flag to an indication of not being ready to harvest a resource table comprising the resource timing information.

6. The method of claim 2, wherein the performing the callback operation comprises:
executing a callback wrapper operation that redefines the callback operation; and
determining a callback execution time associated with the web resource.

7. The method of claim 6, wherein the determining the callback execution time associated with the web resource comprises:
determining a callback execution start time;
executing the callback operation; and
determining a callback execution end time.

8. The method of claim 7, wherein the callback execution time comprises the callback execution start time and the callback execution end time.

9. The method of claim 5, further comprising:
setting a harvest ready flag to an indication of being ready to harvest the resource table comprising the resource timing information, responsive to the performing the callback operation.

10. The method of claim 9, further comprising:
processing a resource table comprising the resource timing information, responsive to the harvest ready flag indicating being ready to harvest the resource table.

11. The method of claim 3, wherein the processing the resource table comprising the resource timing information comprises:
generating a binary sorted proprietary resource list based on a plurality of web resources in the resource table; and
determining the resource timing information associated with the web resource, wherein determining the resource timing information associated with the web resource comprises processing elements of the binary sorted proprietary resource list.

12. The method of claim 11, wherein the determining the callback execution time associated with the web resource comprises:
correlating the callback execution time associated with the web resource with an element of the binary sorted proprietary resource list; and
associating the callback execution time with the resource timing information of the web resource based on the correlating the callback execution time.

13. The method of claim 12, wherein the correlating the callback execution time associated with the web resource with the element of the binary sorted proprietary resource list comprises:
identifying an element of the binary sorted proprietary resource list, wherein the identifying the element of the binary sorted proprietary resource list comprises performing a binary search of the binary sorted proprietary resource list.

14. The method of claim 13, wherein the correlating the callback execution time associated with the web resource with the element of the binary sorted proprietary resource list further comprises:
determining an index of the element of the binary sorted proprietary resource list that was identified; and
identifying the callback execution time associated with the web resource, based on the index of the element of the binary sorted proprietary resource list.

15. An electronic device, comprising:
a processor; and
a memory coupled to the processor and comprising computer readable program code embodied in the memory that when executed by the processor causes the processor to perform operations comprising:
receiving a user selection of a content item on a web page in a web browser executing on a device;
obtaining resource timing information corresponding to network timing information associated with a web resource associated with the content item;
determining a callback execution time associated with the web resource;
aggregating performance information comprising the resource timing information and the callback execution time associated with the web resource; and
communicating, to a network operator, the performance information comprising the resource timing information and the callback execution time associated with the web resource.

16. The electronic device of claim 15, wherein in the processor is further configured to perform operations comprising:
sending a request to obtain the web resource associated with the content item, responsive to the receiving the user selection;
performing a callback operation, responsive to completion of the sending the request; and
processing a resource table comprising the resource timing information, responsive to a completion of the performing the callback operation.

17. The electronic device of claim 16, wherein in the processor is further configured to perform operations comprising:
determining a system request send operation associated with the web resource, responsive to the receiving the user selection;
executing a send wrapper operation that redefines the system request send operation, responsive to the determining the system request operation;
setting a harvest ready flag to an indication of not being ready to harvest a resource table comprising the resource timing information;
executing a callback wrapper operation that redefines the callback operation; and
determining a callback execution time associated with the web resource,
wherein the callback execution time comprises the callback execution start time and the callback execution end time.

18. The electronic device of claim 16, wherein in the processor is further configured to perform operations comprising:
setting a harvest ready flag to an indication of being ready to harvest the resource table comprising the resource timing information, responsive to the performing the callback operation;
generating a binary sorted proprietary resource list based on a plurality of web resources in a resource table, responsive to the harvest ready flag indicating being ready to harvest the resource table; and
determining the resource timing information associated with the web resource, wherein determining the resource timing information associated with the web resource comprises processing elements of the binary sorted proprietary resource list.

19. The electronic device of claim 16, wherein in the processor is further configured to perform operations comprising:
correlating the callback execution time associated with the web resource with an element of the binary sorted proprietary resource list;
identifying an element of the binary sorted proprietary resource list, wherein the identifying the element of the binary sorted proprietary resource list comprises performing a binary search of the binary sorted proprietary resource list;
associating the callback execution time with the resource timing information of the web resource based on the correlating the callback execution time;
determining an index of the element of the binary sorted proprietary resource list that was identified; and
identifying the callback execution time associated with the web resource, based on the index of the element of the binary sorted proprietary resource list.

20. A computer program product, comprising:
a non-transitory computer readable storage medium storing computer readable program code which when executed by a processor of an electronic device causes the processor to perform operations comprising:
receiving a user selection of a content item on a web page in a web browser executing on a device;
obtaining resource timing information corresponding to network timing information associated with a web resource associated with the content item;
determining a callback execution time associated with the web resource;
aggregating performance information comprising the resource timing information and the callback execution time associated with the web resource; and
communicating, to a network operator, the performance information comprising the resource timing information and the callback execution time associated with the web resource.
